(19) United States
(12) Patent Application Publication
(10) Pub. No.: US 2025/0003150 A1
(43) Pub. Date: Jan. 2, 2025

(54) SYSTEM AND METHOD FOR ISOLATING LIGAN AND SYNTHESIZING NANOCELLULOSE FROM LIGNOCELLULLOSIC MATERIALS

(71) Applicant: ALLIANCE BIOENERGY PLUS, INC., DBA BLUE BIOFUELS, Palm Beach Gardens, FL (US)

(72) Inventors: Benjamin SLAGER, Delray Beach, FL (US); Travis Wayne BAUGHMAN, North Palm Beach, FL (US); Eric R. LIBRA, North Palm Beach, FL (US)

(73) Assignee: ALLIANCE BIOENERGY PLUS, INC., DBA BLUE BIOFUELS, Palm Beach Gardens, FL (US)

(21) Appl. No.: 18/690,147

(22) PCT Filed: Sep. 8, 2022
(86) PCT No.: PCT/US22/42842

§ 371 Date: Mar. 7, 2024

Related U.S. Application Data
(60) Provisional application No. 63/241,998, filed on Sep. 8, 2021.
(60) Provisional application No. 63/242,006, filed on Sep. 8, 2021.

(51) Int. Cl. D21B 1/02; C07G 1/00; C08B 15/08

(52) U.S. Cl. CPC D21B 1/021; C07G 1/00; C08B 15/08

(57) ABSTRACT

A method for isolating lignin and synthesizing nanocellulose from lignocellulosic materials is provided. The method describes crushing and grinding the lignocellulosic material under pressure with a solid acid catalyst to induce a solid-solid chemical reaction to depolymerize the lignocellulosic materials into a first product, hydrolyzing the first product into a second product, dissolving the second product in water to form a third product, reslurrying a solid mixture using a flotation reactor, collecting a froth at the top of the reactor and drying the froth to yield lignan. A system is also provided for isolating lignin and synthesizing nanocellulose.

### CROSS-REFERENCE TO RELATED APPLICATIONS

This application is a US National Stage Application of Patent Cooperation Treaty Serial No. PCT/US2022/042842 filed Sep. 8, 2022 entitled System And Method For Isolating Lignan And Synthesizing Nanocellulose From Lignocellulosic Materials which itself claims the benefit of U.S. Provisional Ser. No. 63/241,998 entitled System and Method for Isolating Lignan from Lignocellulosic Materials filed Sep. 8, 2021, and further claims the benefit of U.S. Provisional Ser. No. 63/242,006 entitled System and Method for Synthesizing NanoCellulose from Cellulosic materials filed Sep. 8, 2021, of which the entire contents of each are incorporated by reference herein for all purposes.

### FIELD OF THE INVENTION

The present invention relates generally to the isolation of lignin and nanocellulose from lignocellulosic materials. More particularly, the present invention relates to certain new and useful advances in systems and reaction conditions that can be used to synthesize nanocellulose and separate lignin from cellulose and hemicellulose under mild conditions with minimal degradation to or impurities added to the lignin.

### BACKGROUND

Lignin is an organic polymer, which is found in most plants and which gives structural support. Lignocellulosic material is a common source for sugar production for biofuels. The separation of the lignin from the cellulose, hemicellulose and other components has been conducted in many ways, where in most, such separation requires harsh chemicals or conditions. Current methods for lignin isolation commonly use strong chemicals including strong acids, strong bases, high temperatures and pressures, or enzymatic pathways.

A common iteration of isolated lignin formed during sulfite pulping. When this type of lignin isolation occurs there is a significant decomposition of the lignin polymer with hydrolytic depolymerization to lower molecular weight structures.

Further, nanocellulose has a high potential as a renewable source of green materials. Common ways to form cellulose are chemical, enzymatic, or mechanical. Nanocellulose can be in the form of nanocrystals, nanofibrils, or amorphous. Nanocellulose can be used in the food industry, paper making, pharmaceuticals, as an emulsifier, in polymeric materials, and as a reinforcing filler.

Therefore, a need exists for a system and method to isolate lignin from lignocellulosic materials that obviates the above-recited drawbacks and further synthesizes nanocellulose from lignocellulosic materials under mild conditions with minimal degradation of the nanocellulose material.

### SUMMARY OF THE INVENTION

The following summary of the invention is provided in order to ensure a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented following.

To achieve the foregoing and other aspects and in accordance with the purpose of the invention, the isolation of lignin from lignocellulosic materials and the formation of nanocellulose from lignocellulosic materials allows for certain new and useful advances in systems and methods, which can be used to separate lignin from cellulose and hemicellulose under mild conditions with minimal degradation to or impurities added to the lignin, and form nanocellulose from lignocellulosic materials. The lignan separation system and method may be used on products from systems and methods that utilizes a solid-solid chemical reaction to convert cellulose to sugar using pressure and a catalyst, for example, a set of rollers or grinding elements so as to achieve optimized sugar output from a feedstock of cellulose containing material together with a solid-acid catalyst.

In embodiments, a method for isolating lignin from lignocellulosic materials is provided. The method comprises crushing and grinding the lignocellulosic material under pressure with a solid acid catalyst to induce a solid-solid chemical reaction to depolymerize the lignocellulosic materials into a first product comprising at least cellulose, hemicellulose and nanocellulose, wherein the crusher assembly comprises a pair of rollers configured to crush the lignocellulosic materials therebetween; hydrolyzing the first product into a second product, wherein the second product comprises at least sugars of different chain lengths, dissolving the second product in water to form a third product comprising dissolved sugar and a solid mixture comprising at least the lignin and the solid acid catalyst, reslurrying the solid mixture using a flotation reactor, wherein the floatation reactor bubbles gas into a suspension of the solid mixture to form a froth at a top of the floatation reactor, collecting the froth at the top of the floatation reactor and drying the froth collected to yield the lignin.

In embodiments, a method for synthesizing nanocellulose from lignocellulosic materials is provided. The method comprises grinding the lignocellulosic material to a particle size of less than 2 mm, mixing the lignocellulosic material with a solid acid catalyst to form a mixture, wherein the ratio of materials to solid acid is 0.1-1 to 10-1 of catalyst to feedstock, wherein the solid acid catalyst moisture level is in the range of 1-22% by weight, crushing the mixture in a reaction chamber to induce a solid-solid chemical reaction to depolymerize the lignocellulosic materials into a first product comprising at least cellulose, hemicellulose and nanocellulose, wherein the crusher assembly comprises a pair of rollers configured to crush the lignocellulosic materials therebetween, wherein the reaction chamber temperature is between 60-170° C., and pressure is between 10,000 to 250,000 psi to synthesize nanocellulose.

An advantage of the systems and methods described herein is that isolated lignin remains unsulfurated because there is no sulfur used in the systems and methods described herein. As such, the lignan yield in the systems and methods remains minimally chemically modified as the process for separation is mechanical in nature. This process mechano-chemically breaks down and removes all of the cellulosic components of lignocellulosic material and isolates the minimally modified lignin.

Furthermore, an advantage of the systems and methods herein allows operators to tune a solid-solid chemical reaction to yield desirable nano-cellulose.

Other features, advantages, and aspects of the present invention will become more apparent and be more readily understood from the following detailed description, which should be read in conjunction with the accompanying drawings.

### BRIEF DESCRIPTION OF THE DRAWINGS

Other features, advantages, and aspects of the present platform will become more apparent and be more readily understood from the following detailed description, which should be read in conjunction with the accompanying drawings. Features of the present disclosure are illustrated by way of example and not limited in the following Figure(s), in which like numerals indicate like elements, in which:

FIG. 1 is a perspective front view of an embodiment showing a system, namely a mill, that can be used in the cellulose-to-sugar process, in accordance with one embodiment of the present invention;

FIG. 2 is a perspective front view of the crusher assembly used within the mill, in accordance with one embodiment of the present invention;

FIG. 3 is a step-wise diagram showing a method for isolating lignan from lignocellulosic materials in accordance with one embodiment of the present invention;

FIG. 4 is a combined system and method diagram showing a system and method to transform cellulose to sugar, to synthesize nanocellulose, and to isolate lignan from lignocellulosic materials in accordance with one embodiment of the present invention;

FIG. 5 is a diagram showing a system for isolating lignan from lignocellulosic materials in accordance with one embodiment of the present invention; and

FIG. 6 is a step-wise diagram showing a method for synthesizing nanocellulose from lignocellulosic materials in accordance with one embodiment of the present invention.

The present invention is best understood by reference to the detailed Figures and description set forth herein.

### DETAILED DESCRIPTION OF EMBODIMENTS

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” in may mean “one,” but it is also consistent with the meaning of “one or more,” “at least one,” and “one or more than one.” The use of the term “or” is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

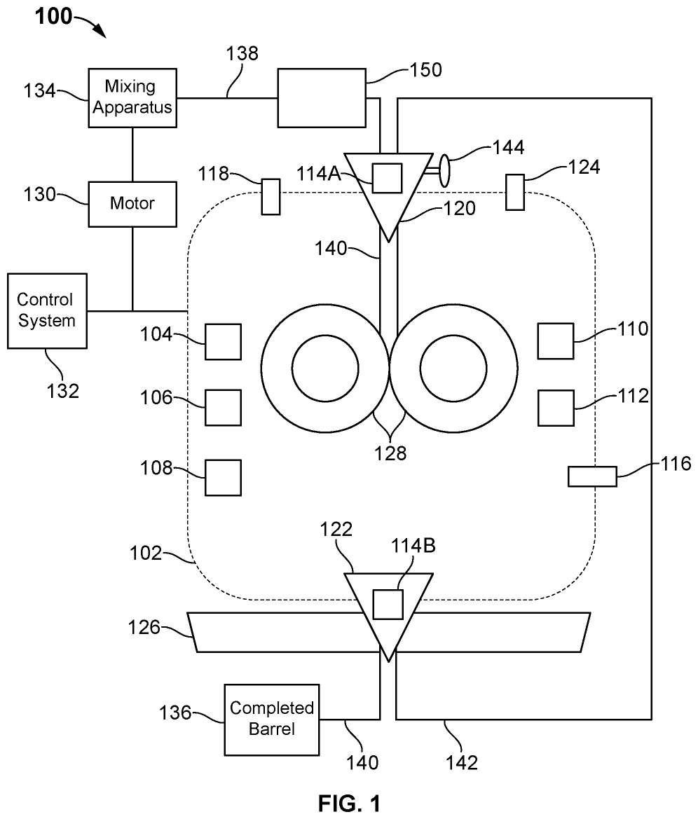

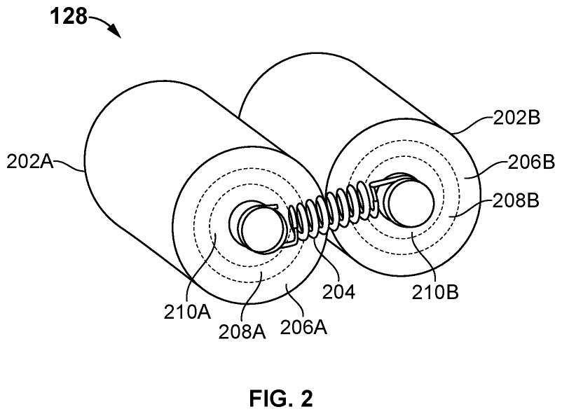

Referring now to FIG. 1, a perspective front view of an embodiment showing a system namely a mill, that can be used in the cellulose-to-sugar process in accordance with one embodiment of the present invention, is presented generally at reference numeral 100. This embodiment 100 illustrates the functional components of the mill 100 in accordance with one embodiment of the present invention. The various components of the mill 100 and their role in the cellulose-to-sugar process will be further described below in relation to FIGS. 1 and 2. The mill 100 comprises a reactor chamber 102 with a plurality of control components. In one embodiment, the plurality of control components comprises an inlet hopper 120, a crusher assembly 128, an outlet hopper 122, a sensor assembly [number?], a steam inlet 118, and a carbon dioxide inlet 124.

Still referring to FIG. 1, a control system 132 is coupled to a drive assembly 130 and both are coupled to the reactor chamber 102. In one embodiment, the drive assembly 130 includes a motor. In one embodiment, the motor 130 is powered via a power supply. By being coupled to the reactor chamber 102, the control assembly 132 is able to communicate and receive information from the various sensors 104-112, vacuum pump 116, heater 126, crusher assembly 128, steam inlet 118, carbon dioxide (CO²) inlet 124 and detectors 114A-114B. Through its interconnectivity, the control assembly 132 allows for real time monitoring, analyzing, and adjusting to ensure that the process is optimized. The foregoing is further discussed herein when describing the other components of the device.

Referring still to FIG. 1, the crusher assembly 128 is configured to induce a chemical reaction in solid phase between the feedstock and the catalyst (e.g., clay). In one embodiment, the crusher assembly 128 may be a single set of approximately smooth rollers (e.g. rounded), but any shape roller may be used so long as it induces appropriate pressure. In another embodiment, the crusher assembly 128 may be a set of intermeshing rollers in the form of gears with high hardness. In some embodiments, the crusher assembly 128 may be any mechanism to compress the solids at very high pressure. The crusher assembly 128 is configured to compress or push together the solids at very high pressure and at a predetermined temperature which aids a solid-solid molecular reaction between the feedstock and the hydrous clay to produce or synthesize sugar utilizing a feedstock. In one embodiment, the solids include, but are not limited to, a lignocellulosic biomass and solid acids. In one embodiment, the ratio of the biomass to the solid acid may be, but is not limited to, 1 kg:0.1-10 kg (kg:kg). In one embodiment, the solid acids may be, but are not limited to, kaolin, bentonite, and montmorillonite or any solid acid existing now or in the future.

Still referring to FIG. 1, the drive assembly 130 and control assembly 132 are also coupled to the mixing apparatus 134, which is where the feedstock and catalyst are mixed; once mixed, the material may be sent to a preheater 150 configured to heat the feedstock and catalyst to a predetermined temperature before it is sent to the inlet hopper 120 via the feed line 138. Once inside the inlet hopper 120, the detector 114A together with any other necessary sensors or detectors analyzes the matter and calculates information that will be useful in the process such as protein content, cellulose, starch, and monomeric sugar, water, lignin, ash, oil, and mechanical properties. In one embodiment, the detector (114A and 114B) is a NIR detector but may be any detector or sensor that analyzes compounds and materials in a mixture. This information will be used to analyze the material to ensure the process performs at the optimal level to ensure consistency and the best yield. In one embodiment, readings from the detector 114A can be utilized by the control assembly 132 to make adjustments to the speed of the crusher assembly 128 to ensure the process is optimized. Once the material is analyzed inside the inlet hopper 120, then the feed valve 144 will be used to open the inlet hopper 120 so that the material may pass from the inlet hopper 120 down into the feed guide 140, which will guide the material down between the crusher assembly 128 located within the reactor chamber 102. As previously discussed, the crusher assembly 128 is powered via the drive assembly 130 and control assembly 132 that are coupled to the reactor chamber 102. In one embodiment, the crusher assembly 128 and the drive assembly 130 are connected via a drive shaft. Once the process is completed, the material exits the reactor chamber 102 via the outlet hopper 122. Once in the outlet hopper 122, the detector 114A and 114B together with any other necessary sensors or detectors analyzes the material to determine whether or not it must be passed through the mill 100 again. If it is determined that the material must be ran through again, then the material will be sent via the return feed line 142 back to the inlet hopper 120, where the detector 114A will analyze the material again, whilst determining the adjustments which must be made to the device in order to reprocess the material. Once the process is completed and the material is no longer required to be run through the crusher assembly 128, then it will be sent to the completed collection device 136 via the exit feed line 140. In one embodiment, an outlet valve could be provided at the feed guide or line 140 to control the flow of the material. In one embodiment, a tight seal is provided to the feed lines 140 and 142 to prevent leakages of the material. It is important to note that more than one crusher assembly 128 may be used in the chamber 102.

Still referring to FIG. 1, the inlet hopper 120 and the outlet hopper 122 are coupled to the reactor chamber 102 and are used to introduce the material into the collection device 102 and to evacuate the material out of the collection device 102, respectively. To open and close the inlet hopper 120 so that the material may enter the reactor chamber 102, a feed valve 144 is used. In the present embodiment, the inlet hopper 120 and outlet hopper 122 are operated based upon an atmospheric control system that regulates pressure in the reactor chamber 102 to enhance conveyance of materials in the system. In other embodiments, the inlet hopper 120 and outlet hopper 122 may be controlled via electronic systems and coupled with the control assembly 132.

Still referring to FIG. 1, a control assembly 132 is coupled to the drive assembly 130 that is further coupled to the crusher assembly 128 which is further coupled to the reactor chamber 102. The drive assembly 130 must provide enough power and torque required to turn the crusher assembly 128 at a predetermined or optimal revolutions per minute and be able to change speeds and power outputs over time. In embodiments, each of the rollers of the crusher assembly 128 may turn at different RPMs in order to optimize the reaction. In one embodiment, the control assembly 132 is a processor that reads the sensors 104-112 and automatically responds to predefined parameters. Real time measurements will allow for real time adjustments to ensure the crusher assembly 128 operates in the optimal manner. As an example, the drive assembly 130 and control assembly 132 may alter the revolutions per minute as needed to adjust the torque and power of the crusher assembly 128 based upon sugar production and responses from the parameter monitoring. In another example, if the temperature sensor 106 sends a reading to the control assembly 132 that the temperature is outside of a predetermined range, then the control assembly 132 will send a corresponding signal to the heater 126 to heat the reactor chamber 102.

Still referring to FIG. 1, the mill 100 further comprises a sensor assembly. In embodiments, the sensor assembly comprises various sensors 104-112, which are coupled to the interior of the reactor mill 102, which include a pH sensor 104, temperature sensor 106, oxygen sensor 108, moisture sensor 110 and pressure sensor 112, all of which are described herein in further detail. All of the sensors 104-112 will also be coupled to the control assembly 132 in order to communicate to the other systems and devices that may be coupled to the reactor chamber 102 to ensure the production of cellulose is at its optimal level, all of which are further described herein. The pH sensor 104 is coupled to the reactor chamber 102 and aids in measuring the effective acidity of the reaction environment. The pH sensor 104 is configured to measure hydrogen ion concentration of the solution which aids in establishing the actual acidity of each site and the number of acid sites. Because hydrolysis is catalyzed by acid sites on the catalyst, a lower pH indicates more acid sites, increasing the changes for hydrolysis to occur. In addition, monitoring the pH levels and assuring certain levels are met will also affect fermentation and/or conversion of the materials loaded into the reactor chamber 102 process. The temperature sensor 106 may be coupled to the reactor chamber 102 and is used to monitor the frictional heat temperature within the reactor chamber 102 to ensure that a high enough temperature is reached to activate the hydrolysis reaction occurring between water and cellulose to make sugar; at the same time, this temperature must also be low enough to avoid reactions that would cause the sugar to degrade.

Still referring to FIG. 1, the oxygen sensor 108 may be coupled to the reaction chamber 102 and is used to monitor oxygen levels within the reaction chamber 102. Because oxygen can cause oxidation of sugar products, it must be removed from the reaction chamber 102 before the cellulose-to-sugar process can be completed. To accomplish the foregoing, the oxygen sensor 108 works in conjunction with the vacuum pump 116, which is also coupled to the reaction chamber 102, such that if the oxygen sensor 108 detects any oxygen within the reaction chamber 102, the oxygen sensor 108 will communicate to the vacuum pump 116 via the control assembly 132, which both the oxygen sensor 108 and vacuum pump 116 are also coupled to, to release such oxygen out of the reaction chamber 102. These sensors may be referred to herein atmospheric equilibrium sensor/devices work in conjunction with other to optimize the conditions in the mill 100.

Still referring to FIG. 1, the oxygen sensor 108 also works in conjunction with the CO2 inlet 124, which is also coupled to the reaction chamber 102 as well as the control assembly 132. Thus, if the oxygen sensor 108 detects oxygen in the reaction chamber 102 and communicates to the vacuum outlet 116 to release the same via the control assembly 132, the carbon dioxide inlet 124 will automatically add protective inert carbon dioxide gas to the reaction chamber 102 in order to maintain a positive CO2 pressure within the reaction chamber 102.

Still referring to FIG. 1, a moisture sensor 110 is coupled to the reaction chamber 102 and is used to monitor the amount of moisture within the reaction chamber 102. In one embodiment of the present invention, moisture acts as a reactant to produce sugar during the cellulose-to-sugar process and is consumed by the reaction. As sugar is produced, the moisture levels in the reaction chamber 102 drops and the moisture localizes to hydrate the more hygroscopic monomeric sugars being produced. Therefore, the moisture sensor 110 is important in the present embodiment to ensure that the moisture levels in the reaction chamber 102 remain at the optimal level for the best reaction. In the present embodiment, the moisture levels may be greater than 0.00% but less than 50% by mass. To ensure the foregoing moisture levels are maintained, a steam inlet 118 is also coupled to the reaction chamber 102 and is used to disperse additional steam into the reaction chamber 102, such that the moisture sensor 110 may communicate via the control assembly 132 with the steam inlet 118 to disperse additional steam into the reaction chamber 102.

Still referring to FIG. 1, spectrum detectors 114A-114B together with any other necessary sensors or detectors are coupled to the inlet hopper 120 and outlet hopper 122, respectively, and may be used to analyze the compositions as they pass through the hoppers. The detectors 114A-114B together with any other necessary sensors or detectors will provide data on protein content, cellulose, starch, water, monomeric sugar, lignin, ash and oil. In future embodiments, algorithms may be used to automate responses through the control assembly 134. In one embodiment, the detector 114B coupled to the outlet hopper 122 will determine whether or not the material must be passed through the device again; if the spectrum detector 114B determines it must be passed through again, then the material is returned to the inlet hopper 120 via the return feed line 142. In one embodiment, a feed pump may be provided at the feed line 142 for returning the material to the inlet hopper 120.

Still referring to FIG. 1, a pressure sensor 112 is coupled to the reaction chamber 102 and is used to monitor the pressure within the reaction chamber 102. The pressure required to induce hydrolysis is created by the crusher assembly 128 within the reaction chamber 102, but the pressure in the reaction chamber 102 must be monitored as the pressure may increase or decrease with the changing temperature, requiring CO² to be added to the reaction chamber 102 via the CO² inlet 124 in order to maintain the optimal pressure for the reaction.

Still referring to FIG. 1, a heater 126 is coupled to the base of the reaction chamber 102. While the heat required for the cellulose-to-sugar process to occur mostly comes from the friction created within the reaction chamber 102 during the process, the initial heating of the reaction chamber 102 may be carried out using the heater 126. In other optional embodiments, the cooling process may be carried out using fans along with heat sinks coupled to the reaction chamber or the gears or rollers themselves and controlled via the control assembly 132. The crusher assembly 128 and the rollers may also be temperature controlled by either internal heating or cooling elements or external heating and cooling elements.

Referring to FIG. 2, a perspective front view of the crusher assembly 128 used within the mill 100 is presented. The crusher assembly 128 comprises two smooth rollers 202A-202B that are pressed together using a spring 204, but any device that is able to produce high pressure may be used, for example, hydraulic pistons, screws and any other mechanism to induce pressure. As discussed herein with reference to FIG. 1, the crusher assembly 128 is turned at a rate by the drive assembly 130, which uses the readings from all of the various sensors 104-112 to determine the optimal rate. The smooth roller is made of materials that have excellent wear properties to endure long run times at high pressures and in embodiments, are manufactured using various materials having differing hardness.

Each of the rollers 202A and 202B may be formed of material having various degrees of hardness (i.e., layers formed of different materials). In exemplar embodiments, the rollers 202A and 202B have three tiers 206A and 206B, 208A and 208B, and 210A and 210B. The outer tier 206A and 206B have, relatively, the highest hardness. The inner tier 210A and 210B has the least or lowest hardness and the middle tier 208A and 208B have a hardness that falls in between the outer tier 206A and 206B and inner tier 210A and 210B. In operation, having the rollers 202A and 202B being formed of varying hardness optimizes the reaction because it increases micro-reactions of the materials. The outer tier 206A and 206B having high hardness ensures that the pressure on the materials remains high and having the middle tier of differing hardness (or softer hardness) ensures that the energy is not lost due to compressive forces in the outer tier being too high and to prevent compression of the roller material. By varying the pressure over the depth of the roller, we can tune the surface and therefore the reaction space and energetic efficiency. The number, thickness, aspect ratio, length, diameter, and material type of layers may be optimized depending upon the feedstocks and such factors influence properties of hardness, toughness, compressive strength, and wear resistance.

In one embodiment, the rollers 202A and 202B may be made with gear teeth because they have hard surfaces, which induces beneficial compressive residual stresses that effectively lower the load stress, in other embodiments, the rollers may be made of strong metals and alloys, tungsten carbide, diamond, plastics, ceramics and composite materials and the like. In an embodiment, the axels that utilize motive force to spin the rollers may be supplied by an adequate supply of cool, clean and dry lubricant that has adequate viscosity and a high pressure-viscosity coefficient may also be used to help prevent pitting, a fatigue phenomenon that occurs when a fatigue crack initiates either at the surface of the gear tooth or at a small depth below the surface. In one embodiment, the bearings could be, but is not limited to, ball bearings. The teeth on the individual gears 202A and 202B must also be designed for most efficient wear properties as well as reaction efficiency in regard to contact area and pressure. While only two sets of rollers are shown, there may be an infinite number of rollers in series. Rollers and gears are composed of surfaces for reaction purposes and contact with feed mixture whereas surfaces of the roller or gear support can compose of surfaces that reduce friction and enhance wear resistance and drive surfaces will be enhanced for the use of pulleys, belts, sprockets, chains, couplings and direct drive attachments.

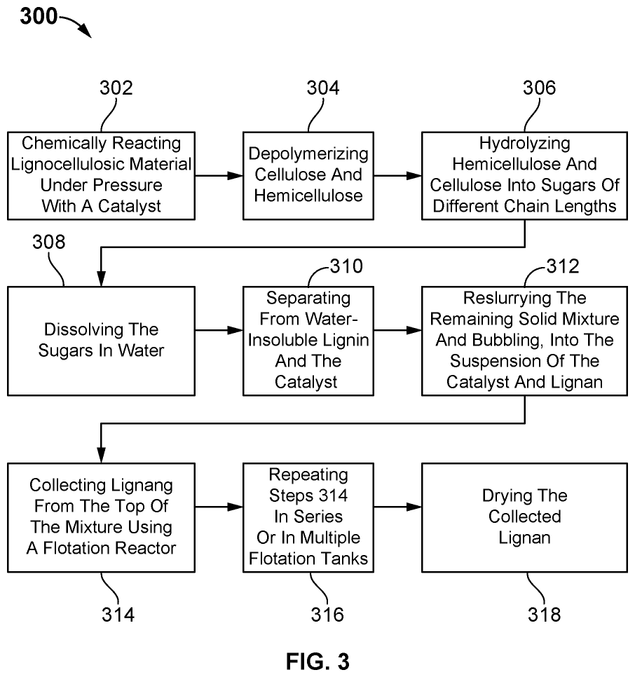

In operation, in the cellulose-to-sugar process described above, cellulose degradation and repolymerization occurs and lignocellulosic materials are formed. A process to isolate lignin from lignocellulosic material is presented herein, and a batch method for the isolation of lignin from lignocellulosic material using the above-described system and a continuous method for the isolation of lignin from lignocellulosic material using the above-described method is now described with reference to FIG. 3, which is a stepwise diagram for such a method.

In operation, lignocellulosic material is chemically reacted by the above-described system in either a batch or continuous process (step 302). The process may use a mild solid acid catalyst to depolymerize cellulose and hemicellulose (step 304). The hemicellulose and cellulose are hydrolyzed into sugars of different chain lengths including but not limited to mono, di, tri, and oligosaccharides, all referred to as sugars (step 306). As the cellulose and hemicellulose are broken down into simpler sugars, they become water-soluble. The sugars can be dissolved in water and separated from the lignin (step 308).

As the sugars and oligomers are dissolved into water, they are separated from the water-insoluble lignin and solid catalyst (step 310). The remaining solid mixture is reslurried and a gas, for example, nitrogen or air, is bubbled into a suspension of the catalyst and lignin where the heavy catalyst falls to the bottom and the lignin froths at the top (step 312). The lignin is collected at the top of the floatation reactor and dried giving pure lignin (step 314). This floatation process may be repeated multiple times or in a series of multiple floatation tanks (optional step 316). The lignan is then dried (step 318) using any known drying method.

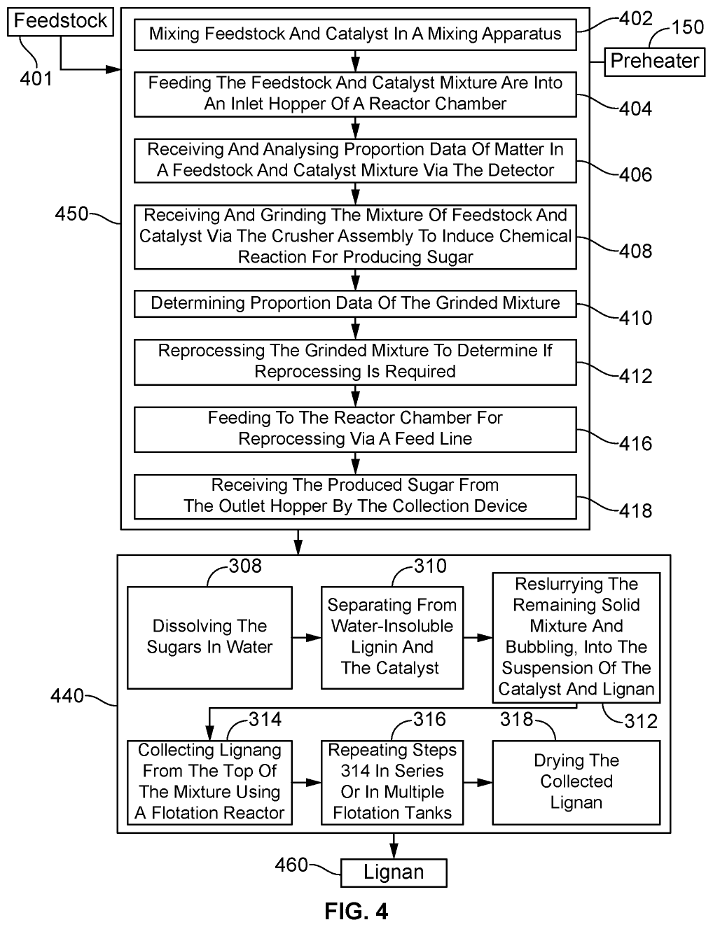

Referring now to FIG. 4, a combined system architecture and method diagram is provided. In embodiments, a feedstock 402 (which may be preheated using preheater 150) is delivered to a cellulose-to-sugar system 450 that operates in a way as shown with regard to FIG. 1 and FIG. 2. The output of the system is then fed to separator 440 and is output as dried lignan 460. At the system 450, a methodology a method for converting cellulose to sugar takes place and comprises, at step 402, a feedstock and a catalyst mixed by a mixing apparatus. At step 404, the feedstock and catalyst mixture are fed into an inlet hopper of a reactor chamber. At step 406, proportion data of matter in a feedstock and catalyst mixture is received and analyzed via the detector. At step 408, the mixture of feedstock and catalyst is received from the inlet hopper to the crusher assembly to grind the mixture to induce a chemical reaction for producing sugar. At step 410, the proportion data of matter in the grinded mixture is determined and delivered by the crusher assembly. At step 412, the reprocessing of the grinded mixture is determined at the control system in communication with the reactor chamber and required to reprocess. At step 414, the grinded mixture is fed to the reactor chamber for reprocessing via a feed line on requirement of reprocessing. At step 416, the produced sugar is received on reprocessing from the outlet hopper by the collection device, and at step 418, output reaction products are received at the collection device. The collection device, which may be a first separator 420 is configured to house the output or yield, and separate nanocellulose 462 from the output.

From the collection device, the output of the system is fed into the separator at which point, the sugars can be dissolved in water and separated from the lignin (step 308). As the sugars and oligomers are dissolved into water, they are separated from the water-insoluble lignin and solid catalyst (step 310). The remaining solid mixture is reslurried and a gas, for example, nitrogen or air, is bubbled into a suspension of the catalyst and lignin where the heavy catalyst falls to the bottom and the lignin froths at the top (step 312). The lignin is collected at the top of the floatation reactor and dried giving pure lignin (step 314). This floatation process may be repeated multiple times or in a series of multiple floatation tanks (optional step 316). The lignan is then dried (step 318) using any known drying method. This entire process may be automated by the collector 440 to output dried lignan.

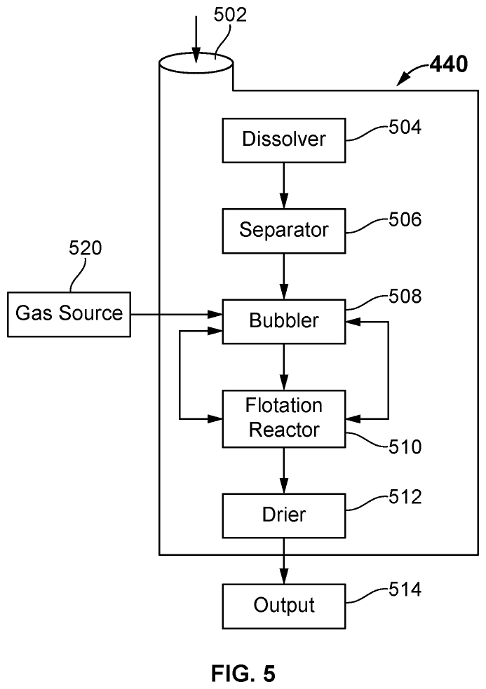

Referring now to FIG. 5, a system diagram showing a system for isolating lignan from lignocellulosic materials in accordance with one embodiment of the present invention. From the collection device to inlet 502, the output of the system is fed into the separator 440 at which point, the sugars can be dissolved in water and separated from the lignin at internal separator 506. The internal separator may be connected to a water source (now shown). As the sugars and oligomers are dissolved into water, they are separated from the water-insoluble lignin and solid catalyst. The remaining solid mixture is fed into bubbler 508 which is coupled to a gas source 516. At the bubbler 508, solid is reslurried and a gas, for example, nitrogen or air, is bubbled into a suspension of the catalyst and lignin where the heavy catalyst falls to the bottom and the lignin froths at the top. The lignin is collected at the top of the floatation reactor 510 and dried giving pure lignin. This floatation reactor 510 may be in communication with the bubbler 508 so that the steps can repeated multiple times or in a series of multiple floatation tanks. The lignan is then dried using at the drier 512 and is output 514. This entire process may be automated by the collector 440 to output dried lignan using sensors, PLCs and internal controls to be configured as an intelligent system.

In order for the cellulose-to-sugar reaction to work optimally to produce lignan, there are several optimal conditions of the feedstock and catalyst. The lignocellulosic feedstock may be milled with a hammer mill, or other types of mills to a fine powder. The particle size of the solid biomass may be in the range of 10-2 mm. The material may have a moister content of 0-15% by weight. It is then combined in the ratio between 0.1:1 and 10:1 catalyst to feedstock by mass with the solid acid catalyst chosen kaolin. The catalyst may have a moisture level in the range of 1-22% by weight. The lignocellulosic feedstock and solids may have physically mixed to have each component evenly distributed. This mixture can be then reacted in a batch reactor in the system described above in a continuous reactor system or other known systems such as a ball mill. In either reactor system, the mild acid catalyst activates water molecules in the material mixture which then hydrolytically cleaves the ether linkages in cellulose and hemicellulose.

In the reactor system, there are several variables that are optimized in order for the material to be processed. In batch mode, the temperature, moisture levels, reaction time, and configuration of the mill are optimized. In the continuous process, the reaction chamber temperature may be 60-170° C., and the pressure achieved at the reaction site may be 10,000-250,000 psi.

Once the reaction is complete in either iteration, the cellulose and hemicellulose are broken down into smaller sugar components. These components are dissolved in water as they have now become water-soluble. The lignin remains insoluble in water and stays a solid. The mild acid catalyst leaves the lignin largely intact with no new chemicals introduced to the system like sulfur. The sugars are then washed away. The lignin is then separated from the solid catalyst by floatation, bubbling gas through the mixture floating the lignin to the top while the solid acid catalyst sinks to the bottom.

In the reactor system, there are several variables that are optimal in order for the material to be processed. In batch mode, the temperature, moisture levels, reaction time, and configuration of the ball mill are optimized for the reaction to proceed. In the continuous process, the reaction chamber temperature may be between 60-170° C., and pressure achieved at the reaction site at 10,000 to 250,000 psi. Once the reaction is complete in either iteration, the cellulose is broken down into smaller components.

### Example #1

100 g of lignocellulosic material with a particle size of 10 microns to 2 millimeters, a moisture level of 0-15% is combined and mixed with 200 g of kaolin with a moisture level of 1-25%. This material is fed through a reactor system at 60-170° C. at a pressure of 10,000-250,000 psi. The solid material product comes out of the reactor system and is combined with 2 L of water with mixing. Nitrogen is bubbled into the mixing solution causing the lignin to froth and rise to the surface. The lignin is skimmed off of the surface, collected, and dried.

### Nanocellulose Formation

In order for the cellulose-to-sugar reaction form nanocellulose, which was unexpected under these conditions, the inventors have found there are several conditions of the feedstock and catalyst that should be optimized and are critical ranges to the formation of nanocellulose using a reaction as described above. In embodiments, the cellulosic feed stock is milled with the above-recited mill, hammer mill, or another type of mill to a fine powder. In embodiments, the particle size of the solid biomass is less than 2 millimeters and combined in a ratio of about 0.1:1 to 10:1 of solid acid catalyst to feedstock with the solid acid catalyst being kaolin, but other solid acid catalysts may be used. In embodiments, the catalyst moisture level is in the range of 1.0-3.0% moisture by weight.

In embodiments, the lignocellulosic feedstock and two solids are physically mixed to have each component evenly distributed. This mixture can be then reacted in a batch reactor in the form of the above-recited system, hammer mill, or ball mill, or continuous reactor system. In either reactor system, the mild acid catalyst activates water molecules in the material which then hydrolytically cleaves the ether linkages in cellulose. The inventors have found that by carrying reaction conditions, one is able to tune the products that are formed; from simple sugars, to larger oligomers, to nanocellulose as described above.

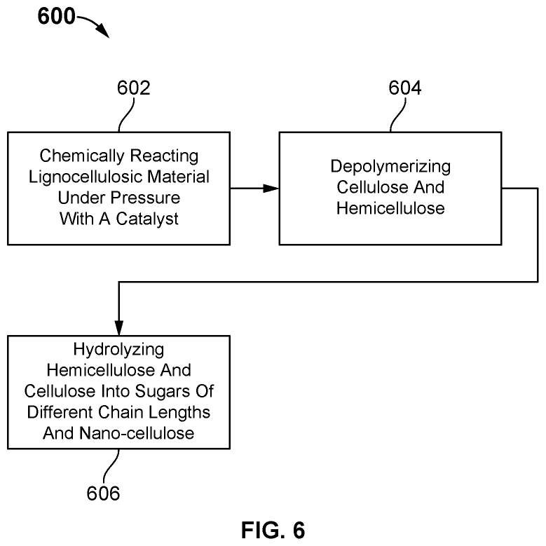

With reference to FIG. 6, a step-wise diagram showing a method for synthesizing nanocellulose from lignocellulosic materials in accordance with one embodiment of the present invention is shown. At step 602, lignocellulosic material is reacted under pressure with a catalyst, at step 604, the cellulose and hemicellulose are depolymerized and as step 606, hemicellulose and cellulose into sugars of different chain lengths and, as an unexpected byproduct of a reaction using the systems and methods described above, nanocellulose,

### Example #2

100 g of lignocellulosic (cellulosic) material with a particle size of less than 2 millimeters and a moisture level of 0-10% is combined and mixed with 100-300 g of kaolin with a moisture level of 1-25%. This material is fed through the above-recited system at 60-170° C. at a pressure of 10,000-250,000 psi. The solid material product that comes out of the reactor system contains a mixture of simple sugars, lignin, and nanocellulose.

Specific configurations and arrangements of the platform, discussed above regarding the accompanying drawing, are for illustrative purposes only. Other configurations and arrangements that are within the purview of a skilled artisan can be made, used, or sold without departing from the spirit and scope of the platform. For example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures.

While the present platform has been described in connection with what are presently considered to be the most practical and preferred embodiments, it is to be understood that the present platform is not limited to these herein disclosed embodiments. Rather, the present platform is intended to mobile phone the various modifications and equivalent arrangements included within the spirit and scope of the appended claims.

Although specific features of various embodiments of the platform may be shown in some drawings and not in others, this is for convenience only. In accordance with the principles of the platform, the feature(s) of one drawing may be combined with any or all the features in any of the other drawings. The words “including,” “comprising,” “having,” and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A method for isolating lignin from lignocellulosic materials, the method comprising:
crushing and grinding the lignocellulosic material under pressure with a solid acid catalyst to induce a solid-solid chemical reaction to depolymerize the lignocellulosic materials into a first product comprising at least cellulose and hemicellulose, wherein the crusher assembly comprises a pair of rollers configured to crush the lignocellulosic materials therebetween;
hydrolyzing the first product into a second product, wherein the second product comprises at least sugars of different chain lengths;
dissolving the second product in water to form a third products, wherein the third product comprises dissolved sugar and a solid mixture comprising at least the lignin and the solid acid catalyst;
reslurrying the solid mixture using a flotation reactor, wherein the floatation reactor is configured to bubble gas into a suspension of the solid mixture to form a froth at a top of the floatation reactor;
collecting the froth at the top of the floatation reactor;
drying the froth collected to yield the lignin.

2. The method of claim 1, wherein the first product comprises nanocellulose.

3. The method of claim 1, wherein the reslurrying step comprises using a series of the floatation reactors.

4. The method of claim 3, further comprising repeating the reslurrying step and the collecting step at the floatation reactors.

5. The method of claim 1, wherein the sugars of different chain lengths comprise monosaccharides, disaccharides, trisaccharide, and oligosaccharides.

6. The method of claim 1, wherein as the cellulose and hemicellulose are broken down into simpler sugars, they become water-soluble.

7. The method of claim 1, further comprising pre-heating the lignocellulosic materials to a predetermined heat prior to the crushing and grinding step.

8. The method of claim 1, wherein the solid acid catalyst is kaolin.

9. The method of claim 1, wherein the grinding step comprises grinding the lignocellulosic materials to a powder having a particle size of 2 millimeters or below.

10. The method of claim 1, wherein the lignocellulosic materials comprise a moister content of 0-15% by weight.

11. The method of claim 9, wherein the solid acid catalyst comprises a moisture level of 1-22% by weight.

12. The method of claim 1, wherein the sugars of different chain lengths comprise monosaccharides, disaccharides, trisaccharide, and oligosaccharides.

13. The method of claim 1, wherein as the cellulose and hemicellulose are broken down into simpler sugars, they become water-soluble.
